(19) United States
(12) Patent Application Publication
(10) Pub. No.: US 2012/0029931 A1
(43) Pub. Date: Feb. 2, 2012

(54) TERMINAL SUPPORTING CLINICAL DECISION, METHOD FOR MEDICATION MANAGEMENT USING THE SAME, AND RECORDING MEDIUM STORING PROGRAM FOR EXECUTING METHOD FOR MEDICATION MANAGEMENT

(76) Inventor: Dongkyu Seo, Seoul (KR)

(21) Appl. No.: 13/057,002

(22) PCT Filed: Jul. 29, 2010
(86) PCT No.: PCT/KR2010/004978

§ 371 Date: Feb. 1, 2011

(51) Int. Cl. G06Q 50/00; G06Q 10/00

(52) U.S. Cl. 705/2

(57) ABSTRACT

A terminal supporting a clinical decision is disclosed. The terminal may include a database, an analysis module, and a communication unit. The database may store an electronic prescription. The analysis module may analyze the electronic prescription to generate electronic prescription analysis results including a prescribed medicine and limitations of the prescribed medicine. The communication unit may transmit the electronic prescription analysis results to at least one external device.

### TECHNICAL FIELD

The present invention relates to a technique for utilizing electronic prescriptions.

### BACKGROUND ART

Recently, as electronic prescriptions are increasingly issued in a medical field, an interest in techniques utilizing such electronic prescriptions is increasing.

### DISCLOSURE

### Technical Problem

An aspect of the present invention provides a terminal capable of analyzing electronic prescriptions, transmitting the analysis results to an electronic prescription generation available institution to allow the institution to share the analysis results, and performing a side effect monitoring function with respect to a medicine taken, and a method for medication management.

Another aspect of the present invention provides a terminal capable of searching for a pharmacy which has a prescribed medicine obtained according to electronic prescription analysis results and providing information regarding a searched pharmacy to a user, and a method for medication management.

Technical ideas devised by the present invention are not limited to those described above and any other technical ideas not mentioned could be clearly understood by a person skilled in the art to which the present invention pertains from the following description.

### TECHNICAL SOLUTION

According to an aspect of the present invention, a terminal supporting a clinical decision may include a database, an analysis module, and a communication unit. The database may store an electronic prescription. The analysis module may analyze the electronic prescription to generate electronic prescription analysis results including a prescribed medicine and limitations in an internal use of the prescribed medicine. The communication unit may transmit the electronic prescription analysis results to at least one external device.

According to another aspect of the present invention, a terminal supporting a clinical decision may include an analysis module, a database, and a communication module. The analysis module may analyze the electronic prescription to generate electronic prescription analysis results including a prescribed medicine and limitations in an internal use of the prescribed medicine.

The database may store side the electronic prescription and side effect questionnaire information for monitoring whether or not there is a side effect according to the internal use of the prescribed medicine. The communication unit may transmit the electronic prescription analysis results to at least one external device and may transmit side effect monitoring information generated based on the side effect questionnaire information to a management system of an institution which has issued the electronic prescription.

According to another aspect of the present invention, a terminal supporting a clinical decision may include an analysis module, a search module, and an output unit. The analysis module may analyze an electronic prescription and generate electronic prescription analysis results including a prescribed medicine and limitations in an internal use of the prescribed medicine. When there are no limitations in the internal use of the prescribed medicine, the search module may search pharmacies for a pharmacy having the prescribed medicine. The output unit may output information regarding the searched pharmacy by using at least one of an audio signal and an image signal.

According to another aspect of the present invention, a method for a medication management using a terminal supporting a clinical decision, may include: storing an electronic prescription; analyzing the electronic prescription to generate electronic prescription analysis results including a prescribed medicine and limitations in an internal use of the prescribed medicine; and transmitting the prescription analysis results to at least one external device.

According to another aspect of the present invention, a method for a medication management using a terminal supporting a clinical decision, may include: analyzing an electronic prescription to generate electronic prescription analysis results including a prescribed medicine and limitations in an internal use of the prescribed medicine; storing the electronic prescription and a side effect questionnaire information for monitoring whether or not a side effect has been generated according to the internal use of the prescribed medicine; and transmitting the electronic prescription analysis results to at least one external device and transmitting side effect monitoring information generated based on the side effect questionnaire information to a management system of an institution which has issued the electronic prescription.

According to another aspect of the present invention, a method for a medication management using a terminal supporting a clinical decision, may include: analyzing an electronic prescription to generate electronic prescription analysis results including a prescribed medicine and limitations in an internal use of the prescribed medicine; when there are no limitations in the internal use of the prescribed medicine, searching pharmacies for a pharmacy having the prescribed medicine; and outputting information regarding the searched pharmacy by using at least one of an audio signal and an image signal.

The respective methods for a medication management according to the exemplary embodiments of the present invention may be implemented by reading a recording medium storing a program for executing the respective methods for a medication management from a computer and executing the program.

### ADVANTAGEOUS EFFECTS

With the terminal supporting a clinical decision and a method for a medication management using the same according to exemplary embodiments of the present invention, a user can be systematically and effectively managed with respect to his prescription by allowing electronic prescription issuance institutions to share the prescription information.

Also, with the terminal supporting a clinical decision and a method for a medication management using the same according to exemplary embodiments of the present invention, the user can be supported for a customized medical treatment based on side effect monitoring information regarding a prescribed medicine on an electronic prescription.

In addition, with the terminal supporting a clinical decision and a method for a medication management using the same according to exemplary embodiments of the present invention, the user can be provided with information regarding a pharmacy having a prescribed medicine on an electronic prescription.

### DESCRIPTION OF DRAWINGS

FIG. 1 is a view illustrating the configuration of a system providing a clinical decision supporting service according to an exemplary embodiment of the present invention.

FIG. 2 is a schematic block diagram o f a terminal supporting a clinical decision according to an exemplary embodiment of the present invention.

FIG. 3 is a view illustrating a method for a medication management using the terminal supporting a clinical decision according to an exemplary embodiment of the present invention.

FIG. 4 is a flow chart illustrating the process of a method for a medication management illustrated in FIG. 3.

FIG. 5 is a view illustrating a method for a medication management using the terminal supporting a clinical decision according to another exemplary embodiment of the present invention.

FIG. 6 is a flow chart illustrating the process of a method for a medication management illustrated in FIG. 5.

FIG. 7 is an overview of a display screen illustrating an example of side effect monitoring information generated by a user in the process of performing the method for a medication management illustrated in FIGS. 5 and 6.

FIG. 8 is an overview of a display screen illustrating another example of side effect monitoring information written by a user in the process of performing the method for a medication management illustrated in FIGS. 5 and 6.

FIG. 9 is an overview of a display screen illustrating an example of a response message with respect to side effect monitoring information received by a terminal in the process of performing the method for a medication management illustrated in FIGS. 5 and 6.

FIG. 10 is a flow chart illustrating the process of a method for a medication management according to another exemplary embodiment of the present invention.

FIG. 11 is a view illustrating implementation results of the method for a medication management illustrated in FIG. 10.

### MODE FOR INVENTION

The foregoing and other objects, features, aspects and advantages of the present invention will become more apparent from the following detailed description of the present invention when taken in conjunction with the accompanying drawings. The present invention may be embodied in many different forms and may have various embodiments, of which particular ones will be illustrated in drawings and will be described in detail. Like numbers refer to like elements throughout. In describing the present invention, if a detailed explanation for a related known function or construction is considered to unnecessarily divert the gist of the present invention, such explanation has been omitted but would be understood by those skilled in the art.

It will be understood that when an element is referred to as being connected with another element, it can be directly connected with the other element or intervening elements may also be present. In contrast, when an element is referred to as being directly connected with another element, there are no intervening elements present. Also, transmitting or outputting by an element, data or a signal to a different element may mean that the element may directly transmit or output the data or signal to the different element or the element may transmit or output the data or signal to the different element through at least one of different elements.

Exemplary embodiments of the present invention will now be described in detail with reference to the accompanying drawings.

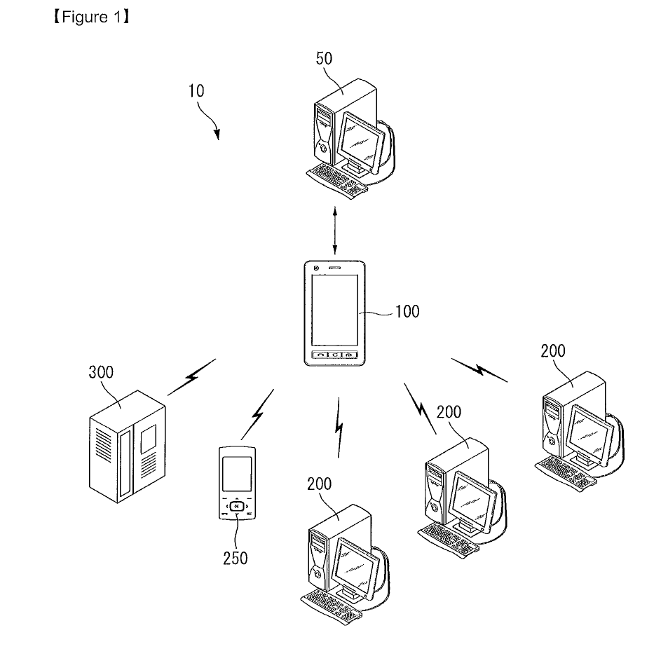

FIG. 1 is a view illustrating the configuration of a system 10 providing a clinical decision supporting service according to an exemplary embodiment of the present invention. The system 10 can analyze an electronic prescription by using a user terminal 100 supporting a clinical decision and transmit the analysis results to an electronic prescription issuance available institution to share them, whereby the prescription of a patient can be systematically and effectively managed, and a customized medical support can be provided by monitoring a side effect according to an internal use of a medicine.

In general, a clinical decision supporting system (CDSS) refers to a system for help the doctor decide a treatment, a prescription, and the like, with respect to a patient. However, in an exemplary embodiment of the present invention, the terminal 100 can support broader clinical decision in the medical field. For example, the terminal 100 may support clinical decision with respect to a medical management after a prescription in a hospital, such as a medication management with respect to a prescribed medicine, a management with respect to a side effect of the prescribed medicine, an analysis of an electronic prescription and utilization of the results, and the like, and in addition, a clinical decision with respect to a health care of the patient, as well as the CDSS function.

With reference to FIG. 1, the system 10 includes a management system 50 of an institution which has issued an electronic prescription, a user terminal 100 supporting a clinical decision, a plurality of management systems 200 of institutions which can issue an electronic prescription, a terminal 250 of an interested person of the institution which has issued the electronic prescription, and a health care server 300, and these are connected through a wired/wireless network to transmit and receive data.

Here, the institution which has isseued the electronic prescription or which may issue an electronic prescription refers to a medical institution which can issue an electronic prescription based on a doctor or a oriental doctor's treatment and electronic sign, such as a general hospital, an oriental hospital, a general practitioner clinic, an Oriental medical clinic, and the like. Each country may have a different electronic prescription-related law, so the range of the medical institutions may differ in each country. Hereinafter, the institution which has issued an electronic prescription will be referred to as an electronic prescription issuance hospital and an institution which is able to issue an electronic prescription will be referred to as an electronic prescription issuance available hospital.

The management system 50 of the hospital which has issued the electronic prescription may transmit the electronic prescription generated based on medical treatment results of a user to the user terminal 100. The management system 50 of the hospital which has issued the electronic prescription may store and manage various types of medical information with respect to the user, such as the user's physical condition, medical treatment history, electronic prescription issuance history, illness history, and the like. In FIG. 1, the management system 50 is illustrated as a management computer, but the present invention is not limited thereto and the management system 50 may be a management server of a hospital or a kiosk dedicated for issuing an electronic prescription. However, the scope of the present invention is not limited thereto.

The user terminal 100 may receive the electronic prescription from the management system 50 of the hospital which has issued the electronic prescription, analyze the electronic prescription, and transmit the electronic prescription analysis results to the management system 200 of the electronic prescription issuance available hospital. Then, the hospitals having the availability of issuing an electronic prescription to the user can share the information included in the electronic prescription, and later, the hospitals can use the information included in the electronic prescription in treating the user and issuing an electronic prescription.

Also, the user terminal 100 may transmit the electronic prescription analysis results to the terminal 250 of the interested person (e.g., the doctor, a nurse) of the hospital which has issued the electronic prescription. The interested person of the hospital which has issued the electronic prescription may use the electronic prescription analysis results in managing data of the user, in treating the user, and in issuing an electronic prescription, or the like. Of course, the terminal 250 of the interested person of the hospital may receive the electronic prescription analysis results through the management system 50 of the hospital which has issued the electronic prescription.

In FIG. 1, although the user terminal 100 and the terminal 250 of the interested person of the hospital are illustrated as mobile phones, the terminals 100 and 250 may be any one of a mobile phone, a smartphone, a notebook computer, a personal computer (PC), a digital broadcasting terminal, a personal digital assistant (PDA), and a portable multimedia player (PMP) which can transmit and receive the electronic prescription-related information through wired/wireless communication, but the present invention is not limited thereto.

The user terminal 100 may transmit the electronic prescription analysis results to the health management server 300. The health management server 300 may collect, analyze, and manage data for the user's health care including the electronic prescription analysis results. For example, the health management server 300 may generate a medication schedule according to the electronic prescription based on the electronic prescription analysis results and provide the same to the user terminal 100. The medication schedule according to the electronic prescription may be generated by the user terminal 100 according to an implementation form of the present invention.

Also, the user terminal 100 may transmit side effect monitoring information regarding a medicine taken according to the electronic prescription written by the user to the management system of the hospital which has issued the electronic prescription. Then, the management system 50 of the hospital which has issued the electronic prescription may transmit a response message with respect to the side effect monitoring information to the user terminal 100, and upon receiving the response message, the user may take a measure for eliminating the side effect generated to the user based on the response message.

The user terminal 100 may search for a pharmacy having the medicine obtained according to the electronic prescription analysis results around the user terminal and recommend the same to the user. In this case, the user terminal 100 may output information regarding the recommended pharmacy by using at least one of an audio signal and an image signal.

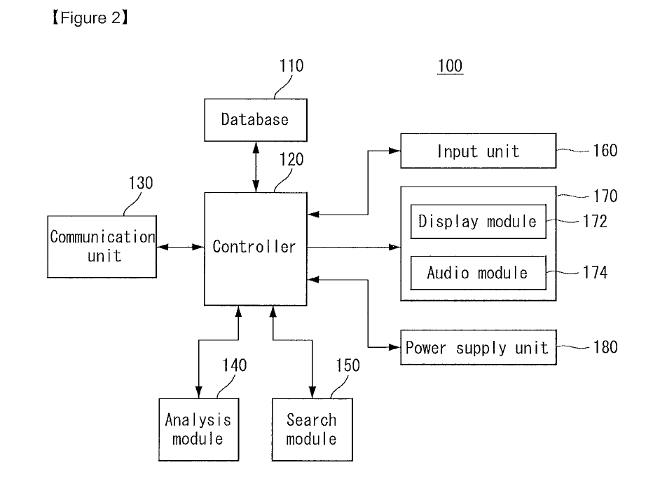

FIG. 2 is a schematic block diagram of a terminal 100 supporting a clinical decision according to an exemplary embodiment of the present invention. With reference to FIG. 2, the terminal 100 includes a database 110, a controller 120, a communication unit 130, an analysis module 140, a search module 150, an input unit 160, an output unit 170, and a power supply unit 180. The operations of the respective elements of the terminal 100 will now be described in detail with reference to FIGS. 1 and 2.

First, the power supply unit 180 may provide power to each element of the terminal 100. The power supply unit 180 may fixed in the terminal 100 or may be detachable. For example, the power supply unit 180 may include a battery. In this case, the battery may be rechargeable through a fixed line or wirelessly, or it may be a solar cell which can produce energy by itself and supply the produced energy to the terminal 100.

The database 110 may store an operating system (OS), various application programs, or the like, for controlling the operation o f the terminal 100. The controller 120 may execute the OS and the application programs stored in the database 110 to generally control the operation of the terminal 100.

Various data generated during the operation of the terminal 100, various data received from the exterior, and the like, may be temporally or permanently stored in the database 110. For example, the electronic prescription with respect to the user or the electronic prescription analysis results may be stored in the database 110.

Also, medical data supporting a clinical decision of the terminal 100, e.g., data regarding a medicine provided as a basis for analyzing the electronic prescription, limitations in an internal use of a medicine, electronic prescription information previously issued for the user, and the electronic prescription analysis program may be stored in the database 110.

The database 110 may be implemented as a flash memory, a hard disk, a RAM (random access memory), an SRAM (static random access memory, a ROM (read only memory), an EEPROM (electrically erasable programmable read only memory), a PROM (Programmable Read Only Memory), or the like, but the present invention is not limited thereto.

The analysis module 140 may analyze the electronic prescription based on data related to supporting the clinical decision stored in the database 110. The electronic prescription may be receive through the communication unit 130 from the management system 50 of the hospital which has issued the electronic prescription according to an implementation form of the present invention, and may be stored in a storage unit and then stored in the database.

When the electronic prescription is received through the communication unit 130, the output unit 170 may output a message informing about the reception of the electronic prescription by using at least one of an audio signal and an image signal. As shown in FIG. 1, the output unit 170 may include a display module 172 for displaying the message informing about the reception of the electronic prescription on a screen and an audio module 174 for outputting the message informing about the reception of the electronic prescription, as an audio signal. Also, the output unit 170 may inform the user about the electronic prescription analysis results by using at least one of an audio signal and an image signal.

Here, the display module 172 may be a display device using at least one of a liquid crystal display, a thin film transistor-liquid crystal display, an organic light-emitting diode, a flexible display, and a 3D display. However, the present invention is not limited thereto. Meanwhile, the audio module 174 may be implemented as a speaker for expressing the data to be informed to the user, as a sound.

The communication unit 130 may communicate with the management system 50 of the hospital which has issued the electronic prescription by using various wired communication techniques such as a wired Internet, power line communication, an optical cable, or the like, by using various short-range wireless communication methods such as Bluetooth™, ZigBee™, Infrared Data Association, Ultra-WideBand (UWB), and the like, or by using various long distance telecommunication techniques such as WLAN (Wireless LAN) (Wi-Fi), Wibro (Wireless broadband), Wimax (World Interoperability for Microwave Access), HSDPA (High Speed Downlink Packet Access), or the like. However, the present invention is not limited thereto. This is the same when the communication unit 130 communicates with the management system 200 of the electronic prescription issuance available hospital.

The analysis module 140 may generate the electronic prescription analysis results including a medicine prescribed according to the electronic prescription and limitations in an internal use of the prescribed medicine. The electronic prescription analysis results may also be stored in the database 110.

The limitations in the internal use of the prescribed medicine may include a limitation in an internal use of the prescribed medicine based on a remaining term for taking the previously prescribed medicine according to a previously issued electronic prescription. This means that the internal use of the prescribed medicine according to the issued electronic prescription may be limited when the term for taking the previously prescribed medicine remains according to the previously issued electronic prescription. For example, when the term for taking the previously prescribed medicine remains, the output unit 170 may output an image message or a voice message of “Please do not take medicine prescribed this time until when the previously prescribed medicine is completely taken!!”. For reference, the previously issued electronic prescription may be an electronic prescription previously issued by the hospital which has issued the electronic prescription, or may be an electronic prescription previously issued by a hospital which can issue the electronic prescription.

The limitations in the internal use of the prescribed medicine may include at least one of age contraindication, combination use contraindication, dosage contraindication, and contraindication according to a repeated prescription, based on the previously prescribed medicine and the prescribed medicine.

Here, the age contraindication refers to a limitation in an age for which an internal use of the previously prescribed medicine and the prescribed medicine is prohibited. If a medicine whose age contraindication is 15 is prescribed for a patient at age 13, the output unit 170 may output an image message or a voice message of “Prescribed medicine is prohibited for a patient under 15!! Please do not take the prescribed medicine!!”.

Here, the combination use contraindication refers to a limitation in an internal use of the prescribed medicine when the prescribed medicine cannot be taken along with the previously prescribed medicine. If the prescribed medicine is a combination use contraindication with the previously prescribed medicine, the output unit 170 may output an image message or a voice message of “You cannot take medicine prescribed this time with previously prescribed medicine!!”.

Here, the dosage contraindication refers to a limitation in dosage of the prescribed medicine allowed to be taken. When a dosage contraindication is one capsule for one time and a medicine of two captures for one time is prescribed, the output unit 170 may output an image message or a voice message of “Medicine prescribed this time exceeds the dosage. Please take only one capsule of the two prescribed capsules!!”.

Here, the contraindication according to a repeated prescription refers to a limitation in an internal use of the prescribed medicine or the previously prescribed medicine when the prescribed medicine and the previously prescribed medicine are repeatedly prescribed. When the prescribed medicine and the previously prescribed medicine are repeatedly prescribed, the output unit 170 may output an image message or a voice message of “Medicine prescribed this time is repeated one of the previously prescribed medicine!! Please take only the medicine prescribed this time!!”.

Meanwhile, when the prescribed medicine corresponds to the internal use limitations (or the limitations in an internal use), the image message or the voice message output from the output unit 170 may be generated based on data stored in the database 110.

The electronic prescription may be an electronic prescription ciphered by using a document encryption algorithm in the management system 50 of the hospital which has issued the electronic prescription. In this case, the analysis module 140 may decode the electronic prescription by using a secret key stored in the database 110 or a secret key generated based on information input through the input unit 160, and then analyze the electronic prescription.

The electronic prescription analysis results may be reflected in a medication schedule of the user. For example, when there are no internal use limitations in the prescribed medicine according to the electronic prescription analysis results, the analysis module 140 may generate a medication schedule of the prescribed medicine. Then, the terminal 100 may output a medication instruction according to the medication schedule through the output unit 170.

In this case, the generated medication schedule may be transmitted in a medicine storage box (not shown) in which the prescribed medicine is kept. Then, the medicine storage box may provide the prescribed medicine to the user according to the generated medication schedule. The medicine storage box may be a portable medicine storage box or an installed type medicine storage box.

The analysis module 140 may generate a medication schedule of a medicine re-prescribed according to an alternative prescription with respect to an electronic prescription which has prescribed the medicine having internal use limitations. When the analysis module 140 generates the medication schedule of the prescribed medicine and generates the medication schedule of the re-prescribed medicine, the medication schedule of the medicine previously prescribed by the previously issued electronic prescription may be considered.

The communication unit 130 may transmit the electronic prescription analysis results to at least one external device. As shown in FIG. 1, the external device may be the management system 200 of the hospital which can issue an electronic prescription, the terminal 250 of the interested person of the hospital which has issued the electronic prescription, the health management server 300, or the like, but the present invention is not limited thereto.

Namely, because the electronic prescription issuance available institution, the health management institution, and the like, share the electronic prescription analysis results transmitted after being generated by the terminal 100 supporting a clinical decision, the patent's health care and prescription can be managed systematically and effectively. The external device may be previously determined according to an implementation form of the present invention, or the user may determine it upon viewing the electronic prescription analysis results.

When there are internal use limitations with respect to the prescribed medicine obtained according to the electronic prescription analysis results and the electronic prescription analysis results are transmitted to the hospital which has issued the electronic prescription, an alternative prescription with the internal use limitations may be issued to the terminal 100. In this case, the output unit 170 may output a message informing about the reception of the alternative prescription, by using at least one of an image signal and a voice signal. Then, the user may check the message and purchase the re-prescribed medicine in a pharmacy based on the information regarding the re-prescribed medicine generated according to the alternative prescription analysis results by the analysis module 140.

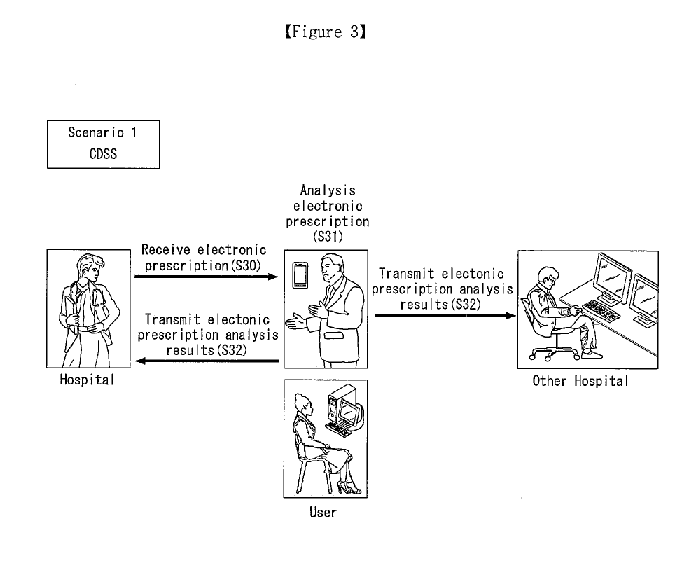

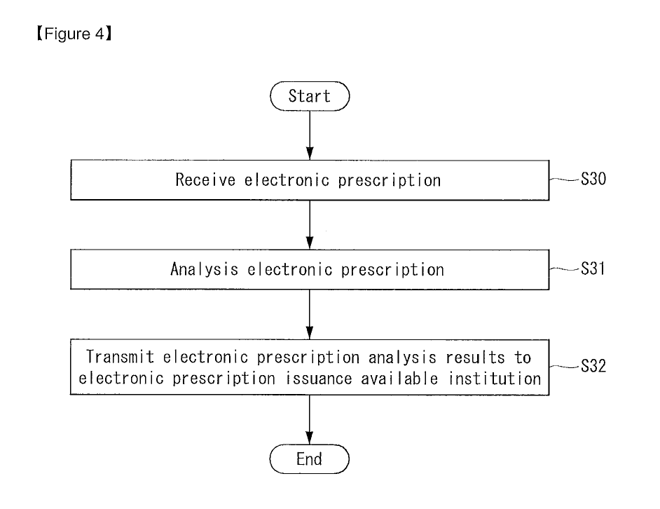

FIG. 3 is a view illustrating a method for a medication management using the terminal supporting a clinical decision according to an exemplary embodiment of the present invention. FIG. 4 is a flow chart illustrating the process of a method for a medication management illustrated in FIG. 3. The sequential process of the method for a medication management will now be described with reference to FIGS. 1 to 4.

The terminal 100 receives an electronic prescription from the management system 50 of the hospital which has issued the electronic prescription through the communication unit 130 (S30), and analyzes the received electronic prescription by using medical data for supporting a clinical decision stored in the database 110, thereby generating a medicine prescribed according to the electronic prescription and precautions in taking the prescribed medicine (S31).

Although not shown in FIGS. 3 and 4, the output unit 170 of the terminal 100 may output a message informing about the reception of the electronic prescription and the electronic prescription analysis results, by using one of an image signal and an audio signal. And then, the terminal 100 transmits the electronic prescription analysis results to the hospital which has issued the electronic prescription and a hospital which may issue an electronic prescription later to share it (S32). When there are internal use limitations in the prescribed medicine, the electronic prescription issuance hospital which as received the electronic prescription analysis results may transmit an alternative prescription without the internal use limitations to the terminal 100.

With reference to FIG. 2, the electronic prescription analysis results by the analysis module 140 may include side effect questionnaire information for monitoring whether or not a side effect is produced according to the internal use of the medicine prescribed according to the electronic prescription. The side effect questionnaire information may be received along with the electronic prescription from the management system 50 of the electronic prescription issuance hospital. In this case, the output unit 170 may output a message informing about the reception of the side effect questionnaire information and display the side effect questionnaire information on the screen of the display module 172.

The user may transmit side effect monitoring information indicating whether or not a side effect has produced according to the internal use of the prescribed medicine generated by the user by using the input unit 160 with reference to the side effect questionnaire information displayed on the screen of the display module 172 to the management system 50 of the electronic prescription issuance hospital. Here, the input unit 160 may include at least one of a keypad, a dome switch, a touch pad (e.g., a touch sensitive member that detects changes in resistance, pressure, capacitance, etc. due to being contacted) a jog wheel, a jog switch, and the like, which generates input data for controlling the operation of the terminal 100 based on a user manipulation. However, the present invention is not limited thereto.

When the side effect monitoring information is received, a hospital manager may transmit a response message with respect to the side effect monitoring information to the user terminal 100 by using the management system 50 of the electronic prescription issuance hospital. Then, the user can quickly take a measure for eliminating the side effect generated to the user based on the response message.

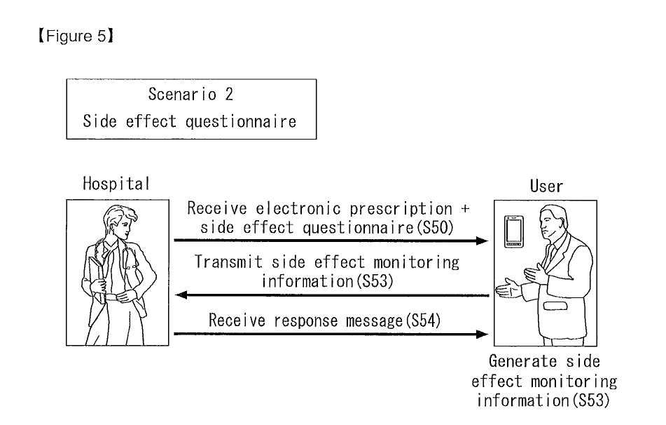

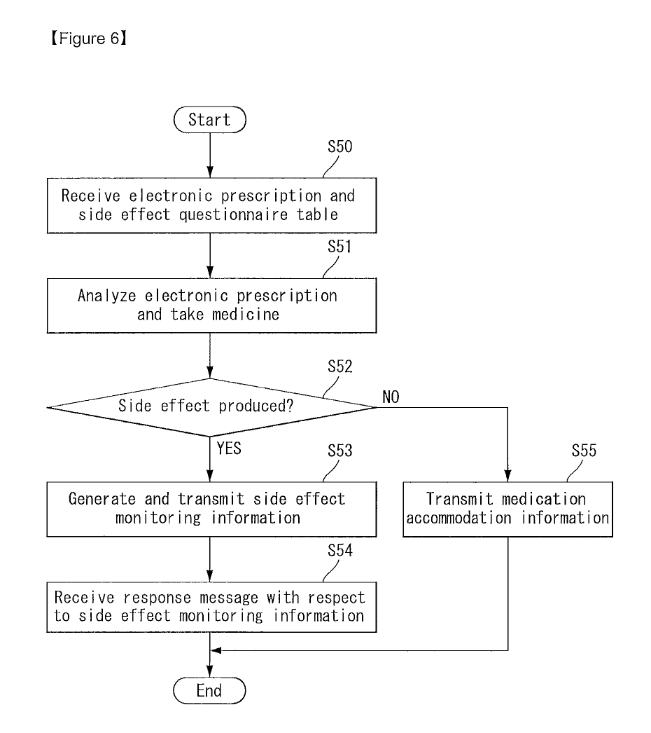

FIG. 5 is a view illustrating a method for a medication management using the terminal supporting a clinical decision according to another exemplary embodiment of the present invention. FIG. 6 is a flow chart illustrating the process of a method for a medication management illustrated in FIG. 5. The sequential process of the method for a medication management will now be described with reference to FIGS. 1, 2, 5 and 6.

The terminal 100 receives an electronic prescription and side effect questionnaire information with respect to an internal use of a prescribed medicine from the management system 50 of the hospital which has issued the electronic prescription through the communication unit 130 (S50). As shown in FIGS. 5 and 6, the side effect questionnaire information may be a side effect questionnaire table. Although not shown in FIGS. 5 and 6, the output unit 170 of the terminal 100 may output the message informing about the electronic prescription and the side effect questionnaire information by using at least one of an image signal and an audio signal.

The user takes the prescribed medicine according to the electronic prescription analysis results, and when a side effect is produced (S52), the user may write side effect monitoring information indicating whether or not a side effect has been produced according to the internal use of the prescribed medicine by using the input unit 160 and then transmits the same to the management system 50 of the electronic prescription issuance hospital(S53). Thereafter, the terminal 100 receives a response message with respect to the side effect monitoring information from the management system 50 of the electronic prescription issuance hospital (S54).

Although not shown in FIGS. 5 and 6, the output unit 170 of the terminal 100 may output a message informing about the reception of the response message with respect to the side effect monitoring information by using at least one of an image signal and an audio signal, and the user may take a measure for eliminating the side effect generated to the user according to the response message with respect to the side effect monitoring information.

When a side effect according to the internal use of the prescribed medicine has not been produced (S52), the user may create medication accommodation information with respect to the prescribed medicine by using the input unit 160 and transmit the created medication accommodation information to the management system 50 of the electronic prescription issuance hospital(S55). Then, the electronic prescription issuance hospital may utilize the medication accommodation information in treating the user and issuing a prescription next time.

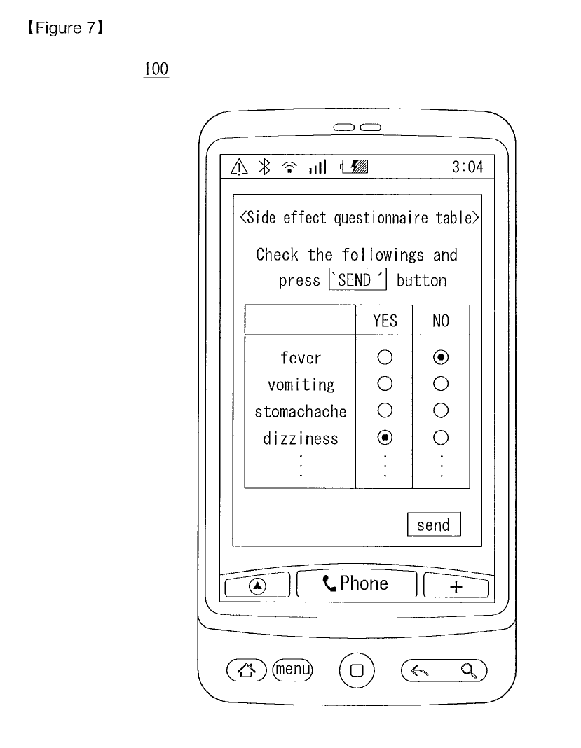

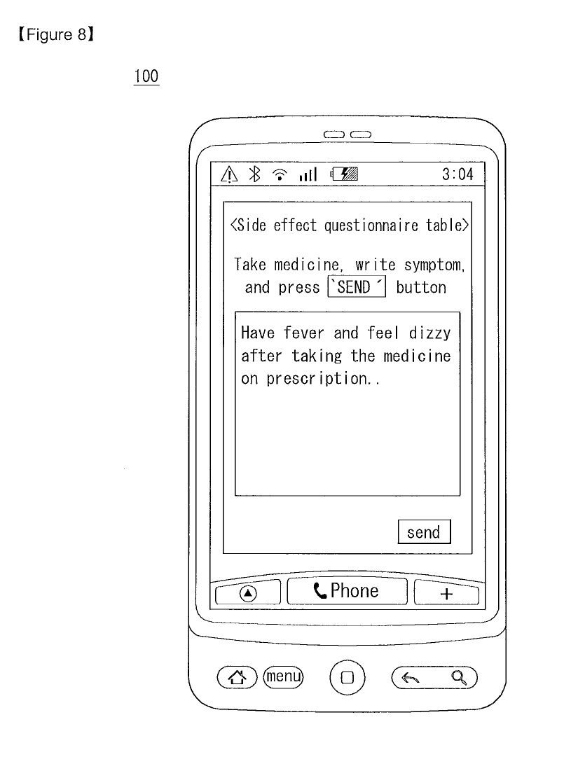

FIG. 7 is an overview of a display screen illustrating an example of side effect monitoring information generated by a user in the process of performing the method for a medication management illustrated in FIGS. 5 and 6. FIG. 8 is an overview of a display screen illustrating another example of side effect monitoring information written by a user in the process of performing the method for a medication management illustrated in FIGS. 5 and 6. For reference, side effect monitoring information illustrated in FIGS. 7 and 8 has a MMS (Multimedia Messaging Service) message form, namely, an MMS message created by the user based on side effect questionnaire information in the form of a side effect questionnaire table received from the management system 50 of the electronic prescription issuance hospital.

With reference to FIG. 7, the side effect questionnaire information includes side effects, e.g., fever, vomiting, stomachache, dizziness, etc., which may be generated to the user when taking the medicine prescribed according to the electronic prescription, and check boxes allowing for checking whether or not each of the side effects are generated. It is noted that the user who took the prescribed medicine has a fever. The user who created the side effect monitoring information may transmit the side effect monitoring information to the management system 50 of the electronic prescription issuance hospital by clicking a “SEND” button at a lower end portion of the screen of the terminal 100,

With reference to FIG. 8, it is noted that the side effect questionnaire information does not include side effects which may be generated to the user when taking a medicine prescribed according to the electronic prescription and corresponding check boxes, and the user may directly input a side effect generated to the user himself. When the user writes the side effect monitoring information, he may transmit the written side effect monitoring information to the management system 50 of the electronic prescription issuance hospital by clicking the “SEND” button at a lower end portion of the screen of the terminal 100.

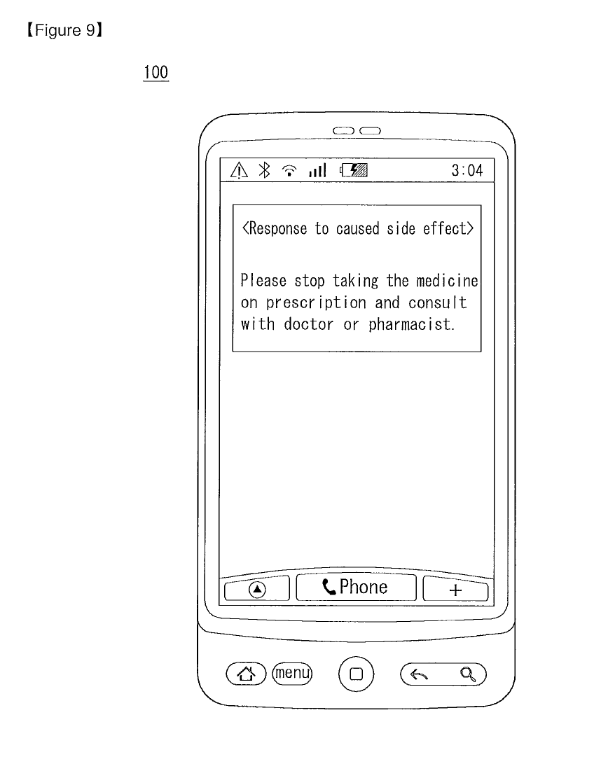

FIG. 9 is an overview of a display screen illustrating an example of a response message with respect to side effect monitoring information received by a terminal in the process of performing the method for a medication management illustrated in FIGS. 5 and 6. For reference, a response message with respect to side effect monitoring information illustrated in FIG. 9 may have an SMS (Short Message Service) message form, which is received from the management system 50 of the electronic prescription issuance hospital.

With reference to FIG. 9, the response message with respect to the side effect monitoring information may include a measure to be taken by the user in order to cope with the side effect generated to the user, namely, content indicating “Please stop taking the medicine according to the prescription and consult with doctor or pharmacy!!”.

A data transmission and reception such as the side effect questionnaire information, the side effect monitoring information, and the response message with respect to the side effect monitoring information between the terminal 100 and the management system 50 of the electronic prescription issuance hospital may be performed by using an e-mail, as well as by using the MMS or the SMS as described above with reference to FIGS. 7 to 9. However, the present invention is not limited thereto.

With reference back to FIG. 2, the search module 150 searches for pharmacies around the terminal 100 for a pharmacy having a medicine prescribed according to an electronic prescription, and recommend it to the user. The pharmacy search conditions of the search module 150 may be pre-set conditions or may be arbitrarily set by the user. For example, pharmacies to be searched may be pharmacies located within 500 meters, a radius previously set by the user, from a current location of the terminal 100.

When there are no limitations in an internal use of the medicine prescribed according to the electronic prescription, the search module 150 may search nearby pharmacies. Also, the search module 150 may search pharmacies around the terminal 100 based on an alternative prescription re-prescribed by eliminating the limitations in the internal use of the prescribed medicine.

Information required for searching by the search module 150 may be directly provided by a management terminal of a pharmacy located near the terminal 100, or may be provided by a service server which provides location information regarding a plurality of pharmacies and collects, processes, manages and provides a medicine stock (or inventory) situation. However, the present invention is not limited thereto. Collecting, processing, and providing of information by using the terminal 100 based on an electronic prescription including the process of collecting, processing and providing information by the search module 150 are anticipated to be automated and standardized in the future.

When searching of recommended pharmacies by the search module 150 is completed, the output unit 170 of the terminal 100 may output information regarding the searched pharmacies by using at least one of an audio signal and an image signal. The information regarding the searched pharmacies may include at least one of the name, address, location information, a phone number, and oral directions of the searched pharmacy. In this case, the output unit 170 may map the location information of the searched pharmacies on a map to display it.

Also, the output unit 170 may guide a route reaching a pharmacy selected by the user from among the searched pharmacies based on the information regarding the searched pharmacies. For example, the terminal 100 may determine a current location of the terminal 100 and locations of the searched pharmacies by using a GPS positioning technique, a positioning technique using a mobile communication network, or the like and guide a route reaching the user selected pharmacy.

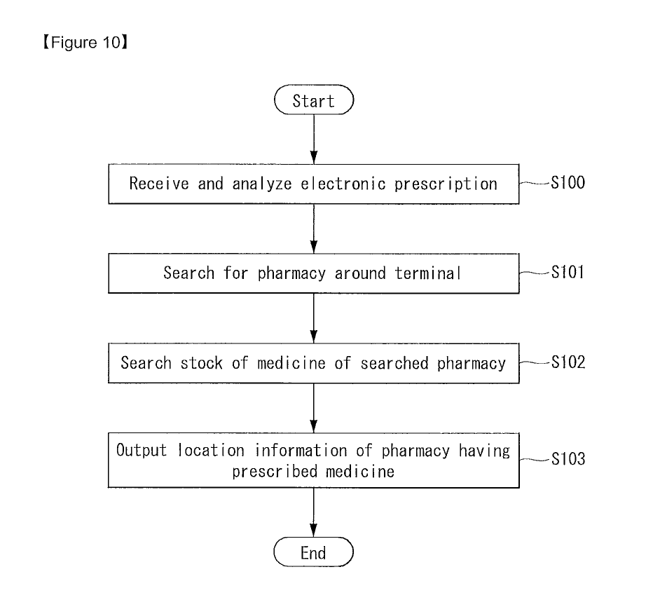

FIG. 10 is a flow chart illustrating the process of a method for a medication management according to another exemplary embodiment of the present invention. The sequential process of the method for a medication management will now be described with reference to FIGS. 1, 2, and 10.

The terminal 100 receives an electronic prescription from the management system 50 of the hospital which has issued the electronic prescription through the communication unit 130, and analyzes the received electronic prescription to generate a medicine prescribed according to the electronic prescription (S100). Thereafter, the search module 150 of the terminal 100 searches pharmacies around the terminal 100 (S101), searches a medicine stock of each of the searched pharmacies, and searches for a pharmacy having the prescribed medicine among the searched pharmacies (S102).

When searching of the pharmacy having the prescribed medicine is completed, the output unit 170 of the terminal 100 outputs the location information of the searched pharmacy by using at least one of an audio signal and an image signal (S103). Then, the user can visit the searched pharmacy with reference to the output location information of the pharmacy to purchase the prescribed medicine.

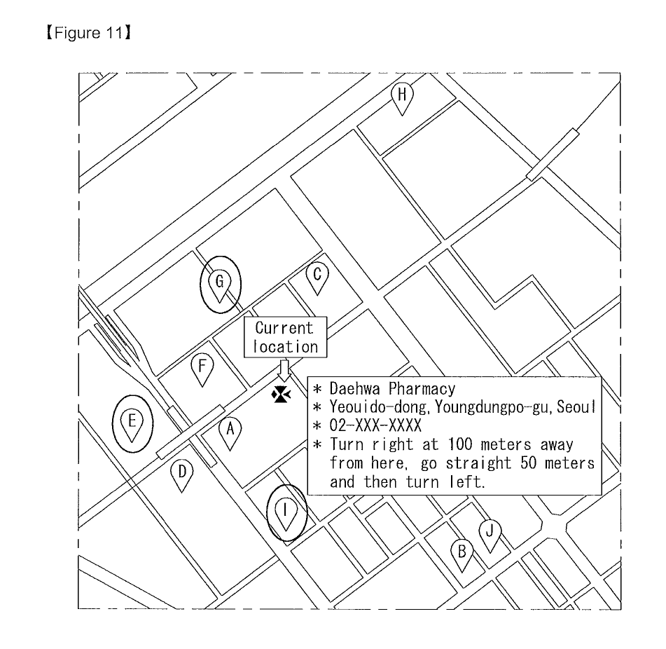

FIG. 11 is a view illustrating implementation results of the method for a medication management illustrated in FIG. 10. With reference to FIG. 11, it is noted that a plurality of pharmacies (A to H) located within a certain radius from the current location of the terminal 100 are searched. In FIG. 11, the pharmacies E, G, and I encompassed by oval figures are pharmacies having the medicine prescribed according to the electronic prescription among the plurality of pharmacies (A to H).

It is noted that the user selects one (I) of the pharmacies displayed on the screen of the terminal 100 and checks information thereof, e.g., the name, address, phone number, and oral directions of the pharmacy. The user may perform various functions by using the information of the pharmacy displayed on the screen of the terminal 100.

For example, when the user selects the oral directions with respect to the selected pharmacy (I), the terminal 100 may guide a route reaching the selected pharmacy through the output unit 170. Also, when the user selects the phone number of the selected pharmacy (I), the terminal may make a call to the phone number.

The methods for a medication management according to the present invention may be implemented in the form of programs which can be performed through various computer units and recorded in a computer-readable medium. The computer-readable medium may include program commands, data files, data structures, and the like, alone or in combination. The programs recorded in the medium may be particularly designed or configured for the present invention or may be known to a person skilled in computer software and used.

Examples of the computer-readable recording medium may include magnetic media such as a hard disk, floppy disk and magnetic tape, optical media such as a CD-ROM or a DVD, a magneto-optical media such as a floptical disk, and a hardware device particularly configured to store and perform a program command such as a ROM (Read Only Memory), a RAM (Random Access Memory), a flash memory, etc. Examples of the program include a high-end language code that can be executable by a computer by using an interpreter, or the like, as well as a mechanical code created by a compiler. The hardware device may be configured to operate by one or more software modules to perform the operation of the present invention, and vice versa.

The preferred embodiments of the present invention have been described with reference to the accompanying drawings, and it will be apparent to those skilled in the art that various modifications and variations can be made in the present invention without departing from the scope of the invention.

Thus, it is intended that any future modifications of the embodiments of the present invention will come within the scope of the appended claims and their equivalents.

### INDUSTRIAL APPLICABILITY

The terminal supporting a clinical decision and the method for a medication management according to exemplary embodiments of the present invention can be used for medical related industries and medicine related industries providing various services related to an electronic prescription and also for network related industries, and communication related industries for providing such services.

1. A terminal supporting a clinical decision, the terminal comprising:
an analysis module configured to analyze an electronic prescription to generate electronic prescription analysis results comprising a prescribed medicine and limitations in an internal use of the prescribed medicine;
a database configured to store the electronic prescription and side effect questionnaire information for monitoring whether or not a side effect has been produced according to the internal use of the prescribed medicine; and
a communication unit configured to transmit the electronic prescription analysis results to at least one external device and to transmit side effect monitoring information genereated based on the side effect questionnaire information to a management system of an institution which has issued the electronic prescription.

2. The terminal of claim 1, wherein the limitations in the internal use of the prescribed medicine comprises at least one of a limitation in an internal use of the prescribed medicine based on a remaining term for taking a previously prescribed medicine according to a previously issued electronic prescription, and age contraindication, combination use contraindication, dosage contraindication, and contraindication according to a repeated prescription, based on the previously prescribed medicine and the prescribed medicine.

3. The terminal of claim 1, further comprising:
an output unit configured to inform a user about the electronic prescription analysis results by using at least one of an audio signal and an image signal.

4. The terminal of claim 1, wherein the communication unit receives the electronic prescription and the side effect questionnaire information.

5. The terminal of claim 1, wherein the communication unit receives the electronic prescription, and the analysis module further generates the side effect questionnaire information.

6. The terminal of claim 1, wherein the external device is a management system of an institution capable of issuing an electronic prescription.

7. The terminal of claim 1, wherein the terminal further comprises an output unit configured to generate a message indicating a reception of a response message with respect to the side effect monitoring information from the management system of the institution which has issued the electronic prescription.

8. A terminal supporting a clinical decision, the terminal comprising:
an analysis module configured to analyze an electronic prescription to generate electronic prescription analysis results comprising a prescribed medicine and limitations in an internal use of the prescribed medicine;
a search module configured to search for a pharmacy having the prescribed medicine, when there are no limitations in the internal use of the prescribed medicine; and
an output unit configured to output information regarding the searched pharmacy by using at least on of an audio signal and an image signal.

9. The terminal of claim 8, wherein the output unit displays location information of the searched pharmacy such that it is matched on a map.

10. The terminal of claim 8, wherein the information regarding the searched pharmacy comprises at least one of the name, address, location information, a phone number, and oral directions of the searched pharmacy.

11. The terminal of claim 8, wherein the output unit guides a route to the searched pharmacy based on the information regarding the searched pharmacy.

12. The terminal of claim 8, further comprising:
a communication unit configured to transmit the electronic prescription analysis results to at least one external device.

13. A terminal supporting a clinical decision, the terminal comprising:
a database configured to store an electronic prescription;
an analysis module configured to analyze the electronic prescription to generate electronic prescription analysis results comprising a prescribed medicine and limitations in an internal use of the prescribed medicine; and
a communication unit configured to transmit the electronic prescription analysis results to at least one external device.

14. The terminal of claim 13, wherein the limitations in the interal use of the prescribed medicine comprises at least one of a limitation in an internal use of the prescribed medicine based on a remaining term for taking a previously prescribed medicine according to a previously issued electronic prescription, and age contraindication, combination use contraindication, dosage contraindication, and contraindication according to a repeated prescription, based on the previously prescribed medicine and the prescribed medicine.

15. The terminal of claim 13, wherein the external device is a management system of an institution capable of issuing an electronic prescription.

16. The terminal of claim 13, wherein the communication unit receives the electronic prescription and side effect questionnaire information for monitoring whether or not a side effect has been produced according to the internal use of the prescribed medicine.

17. The terminal of claim 13, wherein the communication unit receives the electronic prescription, and the analysis module further generates the side effect questionnaire information for monitoring whether or not a side effect has been produced with respect to the internal use of the prescribed medicine.

18. The terminal of claim 16, wherein the communication unit transmits side effect monitoring information generated based on the side effect questionnaire information to a management system of an institution which has issued the electronic prescription, and receives a response message with respect to the side effect monitoring information from the management system.

19. The terminal of claim 13, further comprising:
an output unit configured to generate a message indicating a reception of the electronic prescription and to inform a user about the electronic prescription analysis results by using at least one of an audio signal and an image signal.

20. The terminal of claim 18, further comprising:
an output unit configured to generate a message indicating a reception of the response message, when the response message with respect to the side effect monitoring information is received.

21. A method for a medication management using a terminal supporting a clinical decision, the method comprising:
analyzing an electronic prescription to generate electronic prescription analysis results including a prescribed medicine and limitations in an internal use of the prescribed medicine;
storing the electronic prescription and a side effect questionnaire information for monitoring whether or not a side effect has been generated according to the internal use of the prescribed medicine; and
transmitting the electronic prescription analysis results to at least one external device and transmitting side effect monitoring information generated based on the side effect questionnaire information to a management system of an institution which has issued the electronic prescription.

22. A method for a medication management using a terminal supporting a clinical decision, the method comprising:
analyzing an electronic prescription to generate electronic prescription analysis results including a prescribed medicine and limitations in an internal use of the prescribed medicine;
when there are no limitations in the internal use of the prescribed medicine, searching for a pharmacy having the prescribed medicine; and
outputting information regarding the searched pharmacy by using at least one of an audio signal and an image signal.

23. A method for a medication management using a terminal supporting a clinical decision, the method comprising:
storing an electronic prescription;
analyzing the electronic prescription to generate electronic prescription analysis results including a prescribed medicine and limitations in an internal use of the prescribed medicine; and
transmitting the prescription analysis results to at least one external device.

24. A computer-readable recording medium storing a program for executing the methods for a medication management according to claim 21.
